(19) United States
(12) Patent Application Publication
(10) Pub. No.: US 2009/0219272 A1
(43) Pub. Date: Sep. 3, 2009

(54) PLASMA DISPLAY PANEL DRIVE CIRCUIT AND PLASMA DISPLAY DEVICE

(75) Inventors: Hideki Nakata, Osaka (JP); Satoshi Ikeda, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/279,016

(22) PCT Filed: Feb. 8, 2007
(86) PCT No.: PCT/JP2007/052202

§ 371 Date: Dec. 29, 2008

(30) Foreign Application Priority Data
Feb. 13, 2006 (JP) 2006-034816
Sep. 15, 2006 (JP) 2006-251162

(51) Int. Cl. G06F 3/038; G09G 3/28

(52) U.S. Cl. 345/211; 345/60

(57) ABSTRACT

A PDP driving circuit and a plasma display apparatus with high image quality are realized. The PDP driving circuit of the present invention has a function of lowering the voltage of a recovery capacitor by connecting a step-up circuit including at least an inductor, a switch element, and a diode to the recovery capacitor, and regenerating the excessive voltage of the recovery capacitor to a sustain voltage power supply. Since the luminance can be lowered even in time of light load with low lighting rate by lowering the voltage of the recovery capacitor in time of low lighting rate, a high tone image display is realized, and the PDP driving circuit and the plasma display apparatus with high image quality are realized. In the data electrode driving circuit with slower write timing, the write operation is stabilized by raising the voltage of the recovery capacitor, whereby the PDP driving circuit and the plasma display apparatus with high image quality are realized.

### TECHNICAL FIELD

The present invention relates to a driving circuit of a plasma display panel used in a wall-hanging television and a large monitor, and a plasma display apparatus.

### BACKGROUND ART

An alternating current (AC) area discharge plasma display panel (hereinafter referred to as “PDP”) representative of the AC type has a front surface including a glass substrate on which scan electrodes and sustain electrodes performing area discharge are formed in an array, and a back surface including a glass substrate on which data electrodes are formed in an array arranged facing each other in parallel so that the electrodes form a matrix and a discharge space is formed in the clearance, and the outer peripheral part thereof is sealed by a sealing material such as glass frit. A discharge cell partitioned by a partition wall is formed between the substrates of the front surface and the back surface, and a phosphor layer is formed in a cell space between the partition walls. In the PDP of such configuration, ultraviolet ray is generated by gas discharge, and the phosphor of each color of red (R), green (G), and blue (B) is excited by such ultraviolet ray thereby emitting light and performing color display.

In such plasma display apparatus, various power consumption reducing techniques have been proposed to reduce the power consumption.

As one technique of reducing power consumption, there is disclosed a so-called power recovery circuit, which focuses on the fact that the PDP is a capacitive load, for LC-resonating an inductor and the capacitive load of the PDP by means of a resonance circuit including the inductor as a component, recovering the power accumulated in the capacitive load of the PDP in a power recovery capacitor, and reusing the recovered power for PDP drive (see e.g., patent document 1).

Based on the related art disclosed in patent document 1, there is disclosed a technique of further reducing the power consumption using a timing of switching a power recovery unit and a voltage clamp unit during a sustain period in an electrode driving circuit configuration of the plasma display apparatus (see e.g., patent document 2). The electrode driving circuit configuration disclosed in patent document 2 generates a first discharge when supplying current from the power recovery unit to the panel through LC resonance, and then generates a second discharge by applying a voltage value Vsus to the panel from the voltage clamp unit. The power consumption can be reduced since the peak value of the required current amount can be reduced by successively performing two discharges compared to the case of performing one discharge. In patent document 2, there is also disclosed a technique of varying the timing of two discharges with a lighting rate (value obtained by dividing the number of pixels to be light emitted with the total number of pixels) of the screen.

There is also disclosed a technique of reducing the power consumption in a write period. Since the data electrode is capacitive similar to the scan electrode or the sustain electrode, the charges accumulated in the panel can be recovered in the write period by arranging a circuit similar to the recovery circuit unit arranged in the scan electrode or the sustain electrode driving circuit in the data electrode driving circuit. There is also proposed a circuit of adding a new circuit to the recovery circuit unit and reducing the power consumption (see e.g., patent document 3).

The PDP apparatus disclosed in patent document 3 also has a means for solving the problem in that write operation cannot be correctly performed that arise with larger screen and higher definition of the panel. That is, if the screen becomes larger and the definition becomes higher in the PDP, the address discharge current increases, large voltage drop occurs over the scan pulse, and write operation becomes unstable. The PDP apparatus disclosed in patent document 3 uses a means for changing the timing of data application voltage by the data electrode to prevent the write operation from becoming unstable.

Patent document 1: Japanese Laid-Open Patent Publication No. 7-109542

Patent document 2: Japanese Laid-Open Patent Publication No. 2002-132212

Patent document 3: Japanese Laid-Open Patent Publication No. 2005-49823

### DISCLOSURE OF INVENTION

### Problems To Be Solved By the Invention

In recent years, the panel performance is being enhanced to enhance light emission efficiency of the panel in an aim of reducing the power consumption. That is, the light emission luminance generated in one discharge becomes high. There are also demands to set as much tones as possible to enhance the image quality. In particular, when displaying an image of dark screen, that is, an image of low lighting rate, the light-dark becomes difficult to define if the tone is few in displaying a dark image, and thus the image quality lowers. Therefore, it is desirable to set as much tones as possible to enhance the image quality. At the same time, a drive method of displaying a dark image display in a darker manner by lowering the absolute luminance generated in one discharge is desired.

The PDP apparatus according to the related art disclosed in patent document 1 focuses on the fact that the panel is a capacitive load, and is arranged with a recovery circuit for recovering the charges of the panel and reusing the same, so that an excellent loss reduction effect is achieved. However, since the method of recovering the charges is uniquely defined, the tone or the luminance cannot be changed by the operation of the recovery circuit irrespective of the magnitude of the lighting rate.

The PDP apparatus according to the related art disclosed in patent document 2 reduces the power consumption using two discharges of the discharge from the power recovery unit and the discharge from the voltage clamp unit in the sustain period, as opposed to the first related art. The power consumption is further reduced by changing the time interval of the power recovery unit and the voltage clamp unit according to the lighting rate. However, since the first discharge supplies current through the inductor of the power recovery unit, the current supply amount is determined in the inductor. In other words, the intensity of the first discharge changes by the lighting rate, that is, the number of pixels to be discharged. Therefore, the first light emission luminance of each pixel changes according to the lighting rate in the PDP apparatus disclosed in patent document 2. As a result, when desiring to lower the luminance to create an image with low lighting rate for displaying a dark image, the load becomes smaller the lower the lighting rate, and as a result, the luminance becomes higher. Thus, an image in which the luminance is suppressed low when the lighting rate is low cannot be displayed only using this related art. In the PDP apparatus disclosed in patent document 2, since the intensity of the second discharge is influenced by the intensity of the first discharge, the voltage of the voltage clamp unit is adjusted to control the second light emission luminance. However, a large-capacity capacitor is normally connected in parallel to the voltage clamp unit and a large-capacity power supply is required to adjust the voltage of the voltage clamp unit, and thus the circuit cost increases.

The PDP apparatus according to the related art disclosed in patent document 3 includes the recovery circuit unit in the data electrode driving circuit, and thus is effective in reducing the power consumption compared to the related art in which the recovery circuit unit is not arranged. Furthermore, in the PDP apparatus disclosed in patent document 3, a current limiting circuit is arranged to recover the panel capacity more than the conventional recovery circuit unit, and thus it is desirable in reducing power consumption. However, if the voltage of the recovery capacitor exceeds a set voltage, the recovered power is consumed by a resistor so that the voltage of the recovery capacitor fall within the set voltage in the PDP apparatus disclosed in patent document 3. It is desirable to effectively use the recovered excessive power without being consumed in the resistor.

The technique of temporally shifting the write operation of the data electrode driving circuit in the write period in the PDP apparatus disclosed in patent document 3 is effective in stabilizing the write operation. However, the discharge intensity of the address discharge becomes weak by such temporally shifting operation, and a different problem in that the address operation becomes unstable arises (see FIG. 9). In other words, in the data electrode (e.g., Dm2 in FIG. 9) in which the application timing of the data voltage is slow, a state in which a low data voltage (voltage near Vm2L in FIG. 9) is applied continues for a long time during a period (t1 to t2 in FIG. 9) from when a scan pulse (SCn in FIG. 9) is applied to when the data voltage is applied. The wall charges formed in the reset operation decrease with time by application of such low data voltage. As a result, since the wall charges are already reduced when the data voltage is applied to the data electrode with slower application timing and the write operation is performed, the discharge intensity of the address discharge may become weak. A technique for solving such problems is desired.

### Means For Solving the Problems

The present invention is provided to solve the above problems. A plasma display panel driving circuit according to claim 1 of the present invention is a plasma display panel driving circuit for temporarily forming an LC resonance circuit by connecting an induction element, a switch, and a capacitor to a display panel to supply and recover power with respect to a load capacity of the display panel before and after applying a predetermined voltage to the display panel including the load capacity. The plasma display panel driving circuit includes a control circuit for varying the voltage of the capacitor.

The plasma display panel according to claim 2 of the present invention is the plasma display panel driving circuit according to claim 1, wherein the control circuit controls the voltage of the capacitor to match a reference electrode, and causes a power supply source to recover the power when lowering the voltage of the capacitor.

The plasma display panel according to claim 3 of the present invention is the plasma display panel driving circuit according to claim 2, wherein the control circuit is configured by an induction element having a first end connected to the capacitor; a transistor having a collector terminal connected to a second end of the induction element, and an emitter terminal connected to a negative side power supply of a sustain voltage; and a diode having an anode side connected to the collector terminal of the transistor and a cathode side connected to a positive side power supply of the sustain voltage.

The plasma display panel according to claim 4 of the present invention is the plasma display panel driving circuit according to claim 2, wherein the control circuit is configured by an induction element having a first end connected to the capacitor; a first transistor having a collector terminal connected to a second end of the induction element, and an emitter terminal connected to a negative side of a sustain voltage; a first diode having a cathode side connected to the collector terminal of the first transistor and an anode side connected to the emitter terminal; a second transistor having an emitter terminal connected to the collector terminal of the first transistor, and a collector terminal connected to a positive side power supply of the sustain voltage; and a second diode having a cathode side connected to the collector terminal of the second transistor, and an anode side connected to the emitter terminal.

The plasma display panel according to claim 5 of the present invention is the plasma display panel driving circuit according to any one of claims 1 to 4, wherein the control circuit varies the voltage of the capacitor for every sub-field.

The plasma display panel according to claim 6 of the present invention is the plasma display panel driving circuit according to any one of claims 1 to 4, wherein the control circuit varies the voltage of the capacitor according to a lighting rate.

The plasma display panel according to claim 7 of the present invention is the plasma display panel driving circuit according to any one of claims 1 to 4, wherein the control circuit reduces the capacitor voltage for sub-fields with few tones.

The plasma display panel according to claim 8 of the present invention is the plasma display panel driving circuit according to claim 6, wherein the control circuit varies number of sustain pulses according to the capacitor voltage.

The plasma display panel according to claim 9 of the present invention is the plasma display panel driving circuit according to any one of claims 1 to 8, wherein the control circuit is formed by being connected to the LC resonance circuit configured by being connected to at least a sustain electrode or a scan electrode.

The plasma display panel according to claim 10 of the present invention is the plasma display panel driving circuit according to any one of claims 1 to 8, wherein the control circuit is formed by being connected to the LC resonance circuit configured by being connected to a data electrode.

The plasma display panel according to claim 11 of the present invention is the plasma display panel driving circuit according to claim 10, wherein the control circuit varies the voltage of the capacitor according to change in logical level between adjacent pixel to be address discharged.

The plasma display panel according to claim 12 of the present invention is the plasma display panel driving circuit according to claim 10 or 11, wherein the control circuit holds the voltage of the capacitor during a write period in one sub-field.

A plasma display apparatus according to claim 13 of the present invention is a plasma display apparatus including the plasma display panel driving circuit according to claim 9 or 10.

The plasma display apparatus according to claim 14 of the present invention is the plasma display apparatus according to claim 13, further including at least two or more LC resonance circuit connected to a data electrode; a first control circuit connected to the first LC resonance circuit; and a second control circuit connected to the second LC resonance circuit; wherein a power supply and recovery operation performed by the first LC resonance circuit is faster than a power supply and recovery operation preformed by the second LC resonance circuit.

The plasma display apparatus according to claim 15 of the present invention is the plasma display apparatus according to claim 14, wherein the first control circuit and the second control circuit are operated so that a capacitor voltage of the first LC resonance circuit and a capacitor voltage of the second LC resonance circuit are different.

The plasma display apparatus according to claim 16 of the present invention is the plasma display apparatus according to claim 15, wherein the capacitor voltage of the first LC resonance circuit is smaller than the capacitor voltage of the second LC resonance circuit.

The plasma display apparatus according to claim 17 of the present invention is the plasma display apparatus according to claim 16, wherein an inductance of an induction element of the first LC resonance circuit is smaller than an inductance of an induction element of the second LC resonance circuit.

### Effects of the Invention

As described above, in the plasma display panel driving circuit according to the present invention, the luminance during the sustain period can be reduced, and thus the tone can be increased, and a plasma display apparatus with high image quality can be provided. Furthermore, since the first discharge can be stably controlled even if the lighting rate is changed, the second discharge also stabilizes, and the quality of display enhances. At the same time, the light emission mode of the PDP also stabilizes, whereby the current to be consumed stabilizes and the power consumption can be reduced.

As described, in the plasma display apparatus according to the present invention, the excessive charges can be supplied to the power supply voltage when limiting the potential of the recovery capacitor in the write period, and thus the power consumption can be further reduced. Furthermore, effects such as miniaturization of the circuit are also obtained as heat generation by the resistor is eliminated.

As described above, in the plasma display apparatus according to the present invention, the voltage required during a period until voltage is applied to the data electrode can be reduced even in a case where a power recovery circuit is arranged on the data electrode side, and the timing of write operation is differed in the write period. Consequently, decrease in wall charges in the relevant period is prevented, whereby the write operation stabilizes, and the quality of display becomes higher.

### BRIEF DESCRIPTION OF DRAWINGS

FIG. 1 is a perspective view showing a configuration of a plasma display panel according to an embodiment of the present invention.

FIG. 2 is a view showing an electrode array of the plasma display panel according to the embodiment of the present invention.

FIG. 3 is a voltage waveform chart applied during one sub-field period to each electrode of the plasma display panel according to the embodiment of the present invention.

FIG. 4 is a block configuration view showing, for every function block, a plasma display apparatus according to the embodiment of the present invention.

FIG. 5 is a specific circuit diagram of a scan electrode driving circuit and a sustain electrode driving circuit in the plasma display apparatus according to the first embodiment of the present invention.

FIG. 6 is a specific circuit diagram of a sustain pulse generating circuit of a plasma display panel driving circuit according to a second embodiment of the present invention.

FIG. 7 is a specific circuit diagram of a data voltage generating circuit of a plasma display panel driving circuit according to a third embodiment of the present invention.

FIG. 8 is a specific circuit diagram of a data voltage generating circuit of a plasma display panel driving circuit according to a fourth embodiment of the present invention.

FIG. 9 is a view showing temporal change of a voltage applied to the scan electrode and the data electrode during the write period in the plasma display apparatus according to fifth and sixth embodiments of the present invention.

### DESCRIPTION OF SYMBOLS

1 A/D converter
2 image signal processing circuit
3 sub-field processing circuit
4 data electrode driving circuit
5 scan electrode driving circuit
6 sustain electrode driving circuit
10 PDP
20 front surface
22 scan electrode
23 sustain electrode
24 dielectric layer
25 protective layer
30 back surface
32 data electrode
33 dielectric layer
34 partition wall
35 phosphor layer
41, 41A, 41B data voltage generating circuit
51, 51A, 51B sustain pulse generating circuit
52 reset waveform generating circuit
53 scan pulse generating circuit
C1 first recovery capacitor
C2 second recovery capacitor
C31 scan voltage capacitor
D1 first high side recovery diode
D2 first low side recovery diode
D3 second high side recovery diode
D4 second low side recovery diode
D6 third recovery diode
D31 scan voltage backflow prevention diode
IC31 SCAN driver
L1 first inductor
L2 second inductor
L3 third inductor
S1 first high side recovery switch element
S2 first low side recovery switch element
S3 second high side recovery switch element
S4 second low side recovery switch element
S5 first high side sustain switch element
S6 first low side sustain switch element
S7 second high side sustain switch element
S8 second low side sustain switch element
S9 first separation switch element
S10 second separation switch element
S12 third high side recovery switch element
S13 third low side recovery switch element
S21 reset positive pulse switch element
S22 reset negative pulse switch element
S31 high side scan switch element
S32 low side scan switch element
S41 first data electrode drive high side recovery switch element
S42 first data electrode drive low side recovery switch element
S43 data electrode drive high side sustain switch element
S44 data electrode drive low side sustain switch element
S46 second data electrode drive high side recovery switch element
S47 second data electrode drive low side recovery switch element
C41 data electrode drive recovery capacitor
L41 first data electrode drive inductor
L42 second data electrode drive inductor
D41 data electrode drive high side recovery diode
D42 data electrode drive low side recovery diode
D43 data electrode drive diode
X sustain electrode of PDP 10
Y scan electrode of PDP 10
Cp panel capacity of PDP 10

### BEST MODE FOR CARRYING OUT THE INVENTION

Suitable embodiments according to the present invention will now be described with reference to the drawings.

### First Embodiment

### PDP Driving Circuit

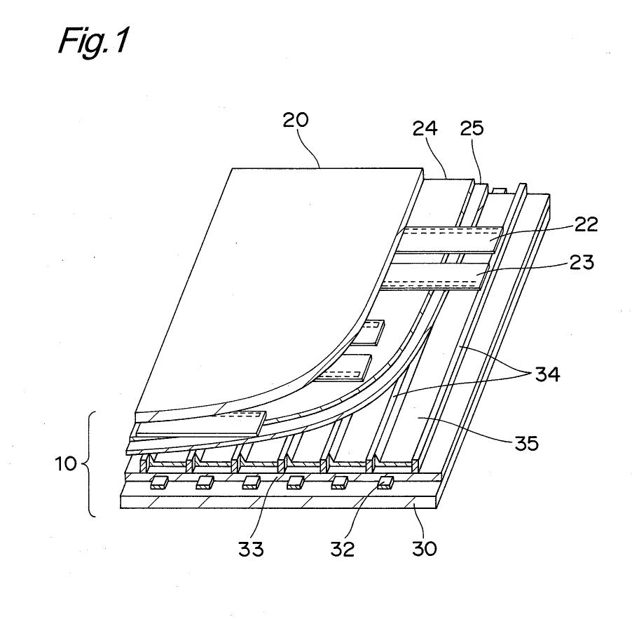

FIG. 1 is a perspective view showing a structure of a PDP 10 according to an embodiment of the present invention. A display electrode forming a pair with a scan electrode 22 having a stripe form and a sustain electrode 23 having a strip form is formed in plurals on a front surface 20 made of glass serving as a first substrate. A dielectric layer 24 is formed to cover the scan electrode 22 and the sustain electrode 23, and a protective layer 25 is formed on the dielectric layer 24.

A plurality of data electrodes 32 having strip form covered by a dielectric layer 33 is formed on a back surface 30 serving as a second substrate so as to three-dimensionally intersect the scan electrode 22 and the sustain electrode 23. A plurality of partition walls 34 is arranged parallel to the data electrode 32 on the dielectric layer 33, and a phosphor layer 35 is arranged on the dielectric layer 33 between the partition walls 34. The data electrode 32 is arranged at a position between the adjacent partition walls 34.

The front surface 20 and the back surface 30 are arranged facing each other with a microscopic discharge space in between so that the scan electrode 22 and the sustain electrode 23 become orthogonal to the data electrode 32, and the outer peripheral part thereof is sealed by a sealing material such as glass frit. A mixed gas, for example, of neon (Ne) and xenon (Xe) is sealed in the discharge space as discharge gas. The discharge space is partitioned into a plurality of partitions by the partition wall 34, and the phosphor layer 35 that emits light of each color of red (R), green (G), and blue (B) is sequentially arranged in each partition. A discharge cell is formed at a portion where the scan electrode 22 and the sustain electrode 23, and the data electrode 32 intersect, and three adjacent discharge cells formed with the phosphor layer 35 that emits light of each color configure one pixel. A region formed with the discharge cells configuring the pixel becomes an image display region, and the periphery of the image display region becomes a non-display region where the image display is not carried out, for example, the region formed with the glass frit.

### Plasma Display Panel (PDP)

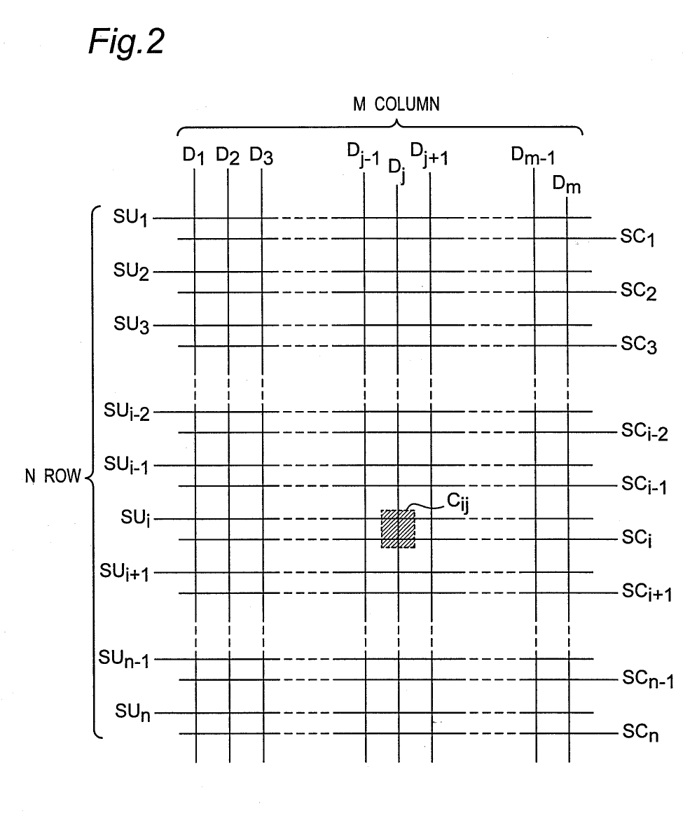

FIG. 2 is an electrode array diagram of a PDP 10 according to an embodiment of the present invention. The scan electrodes SC1 to SCn (scan electrode 22 of FIG. 1) of n rows and the sustain electrodes SU1 to SUn (sustain electrode 23 of FIG. 1) of n rows are alternately arrayed in a row direction, and the data electrodes D1 to Dm (data electrode 32 of FIG. 1) of m columns are arrayed in a column direction. The discharge cell Ci, j including the pair of scan electrode SCi and the sustain electrode SUi (i=1 to n), and one data electrode Dj (j=1 to m) is formed in the discharge space, where the total number of discharge cells C is (m×n).

In the PDP 10 of such configuration, the ultraviolet light is generated by gas discharge, and the phosphor of each color of R, G, B is excited by such ultraviolet light thereby emitting light and performing color display. The PDP 10 divides one field period into a plurality of sub-fields, and is driven by a combination of the sub-fields to be light emitted to carry out a tone display. Each sub-field includes an reset period, a write period, and a sustain period, where different signal waveforms are respectively applied to each electrode in the reset period, the write period, and the sustain period to display the image data.

### Drive Voltage Waveform of PDP

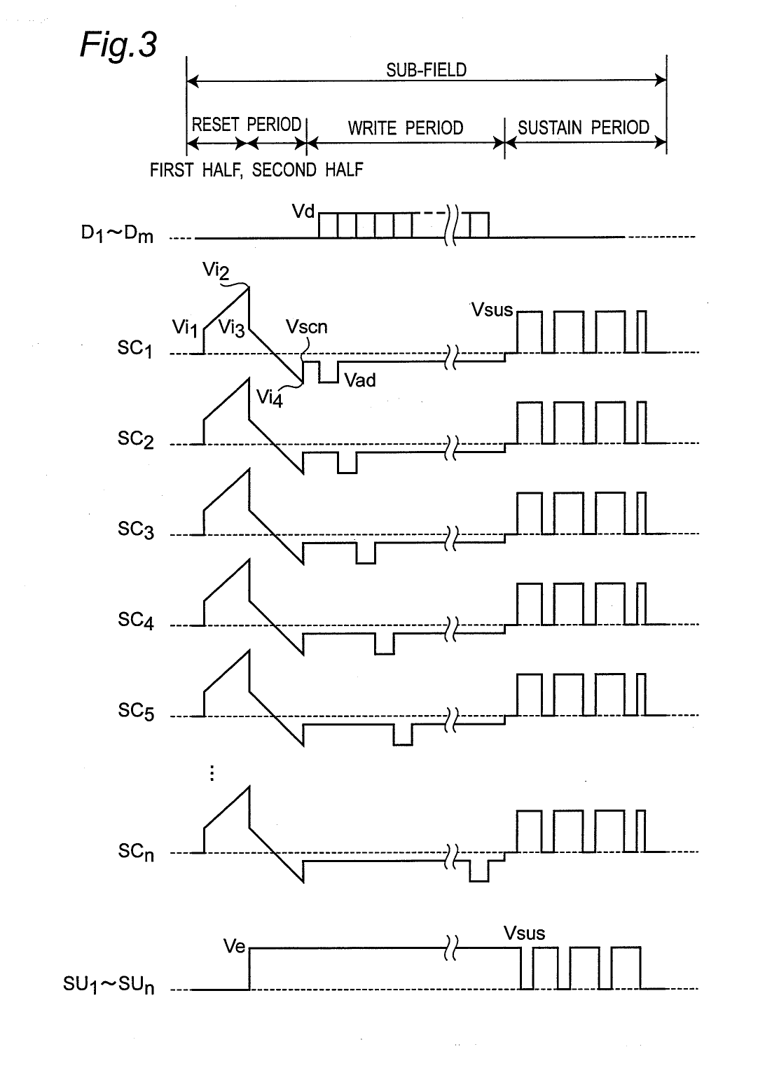

FIG. 3 is a view showing each drive voltage waveform to be applied to each electrode of the PDP 10 according to the embodiment of the present invention. As shown in FIG. 3, each sub-field includes the reset period, the write period, and the sustain period. The sub-fields perform substantially the same operation other than that the number of sustain pulses in the sustain period is differed to change the weight of the light emission period, and the principle of operation in each sub-field is also substantially the same, and thus the operation will be described for one sub-field.

First, in the reset period, the positive pulse voltage is applied to all the scan electrodes SC1 to SCn, and the necessary wall charges are accumulated in the protective layer 25 on the dielectric layer 24 covering the scan electrodes SC1 to SCn and the sustain electrodes SU1 to SUn, and in the phosphor layer 35.

Specifically, in the first half of the reset period, the data electrodes D1 to Dm, and the sustain electrodes SU1 to SUn are respectively held at 0 (V), and an inclined waveform voltage that gradually rises from a voltage Vi1 being lower than or equal to a discharge start voltage to a voltage Vi2 exceeding the discharge start voltage with respect to the data electrodes D1 to Dm is applied to the scan electrodes SC1 to SCn. A first faint reset discharge occurs between the scan electrodes SC1 to SCn, and the sustain electrodes SU1 to SUn and the data electrodes D1 to Dm, respectively, while the inclined waveform voltage is rising. The negative wall voltage is accumulated at the upper part of the scan electrodes SC1 to SCn, and the positive wall voltage is accumulated at the upper part of the data electrodes D1 to Dm and the upper part of the sustain electrodes SU1 to SUn. The wall voltage at the upper part of the electrode represents the voltage generated by the wall charges accumulated on the dielectric layer covering the electrode.

In the second half of the reset period, the sustain electrodes SU1 to SUn are maintained at a positive voltage Ve, and an inclined waveform voltage that gradually falls from a voltage Vi3 being lower than or equal to the discharge start voltage towards a voltage Vi4 exceeding the discharge start voltage with respect to the sustain electrodes SU1 to SUn is applied to the scan electrodes SC1 to SCn. Meanwhile, a second faint reset discharge occurs between the scan electrodes SC1 to SCn, and the sustain electrodes SU1 to SUn and the data electrodes D1 to Dm, respectively. The negative wall voltage at the upper part of the scan electrodes SC1 to SCn and the positive wall voltage at the upper part of the sustain electrodes SU1 to SUn are weakened, and the positive wall voltage at the upper part of the data electrodes D1 to Dm is adjusted to a value suited for the write operation. The reset operation is then terminated (drive voltage waveform to be applied to each electrode in the reset period is hereinafter abbreviated as “reset waveform”).

In the write period, scanning is carried out by sequentially applying a negative scan pulse to all the scan electrodes SC1 to SCn. The positive write pulse voltage is applied to the data electrodes D1 to Dm based on the display data while scanning the scan electrodes SC1 to SCn. The write discharge thereby occurs between the scan electrodes SC1 to SCn and the data electrodes D1 to Dm, and the wall charges are formed at the surface of the protective layer 25 on the scan electrodes SC1 to SCn.

Specifically, the scan electrodes SC1 to SCn are once held at a voltage Vscn in the write period. In the write operation of the discharge cells Cp, 1 to Cp, m (p is an integer between 1 to n), the scan pulse voltage Vad is applied to the scan electrode SCp, and the positive write pulse voltage Vd is applied to the data electrode Dq (Dq is the data electrode selected based on the image signal from D1 to Dm) corresponding to the image signal to be displayed on the p^{th} row of the data electrodes D1 to Dm. The write discharge thus occurs at the discharge cell Cp, q corresponding to the intersecting part of the data electrode Dq applied with the write pulse voltage and the scan electrode SCp applied with the scan pulse voltage. According to such write discharge, the positive voltage is accumulated at the upper part of the scan electrode SCp of the discharge cell Cp, q, the negative voltage is accumulated at the upper part of the sustain electrode SUp, and the write operation is terminated. Similar write operation is carried out up to the discharge cell Cn, q of the n^{th} row, and the write operation is terminated.

In the following sustain period, a voltage sufficient to sustain discharge between the scan electrodes SC1 to SCn and the sustain electrodes SU1 to SUn is applied for a constant period. A discharge plasma is thus generated between the scan electrodes SC1 to SCn and the sustain electrodes SU1 to SUn, thereby causing the phosphor layer to excite and emit light for a constant period. Here, discharge does not occur, and excitation and light emission of the phosphor layer 35 do not occur in the discharge space where the write pulse voltage was not applied in the write period.

Specifically, in the sustain period the scan electrodes SC1 to SCn are once returned to 0 (V), and thereafter, the sustain electrodes SU1 to SUn are returned to 0 (V). Subsequently, the positive sustain pulse voltage Vsus is applied to the scan electrodes SC1 to SCn. In this case, the voltage between the upper part of the scan electrode SCp and the upper part of the sustain electrode SUp at the discharge cell Cp, q that caused the write discharge is added with the wall voltage accumulated at the upper part of the scan electrode SCp and the upper part of the sustain electrode SUp in the write period in addition to the positive sustain pulse voltage Vsus so as to become larger than the discharge start voltage, whereby the first sustain discharge occurs. At the discharge cell Cp, q that caused the sustain discharge, the negative voltage is accumulated at the upper part of the scan electrode SCp to cancel out the potential difference between the scan electrode SCp and the sustain electrode SUp at the time of occurrence of the sustain discharge, and the positive voltage is accumulated at the upper part of the sustain electrode SUp. The first sustain discharge is thereby terminated. After the first sustain discharge, the scan electrodes SC1 to SCn are returned to 0 (V), and thereafter, Vsus is applied to the sustain electrodes SU1 to SUn. In this case, the voltage between the upper part of the scan electrode SCp and the upper part of the sustain electrode SUp at the discharge cell Cp, q that caused the first sustain discharge is added with the wall voltage accumulated at the upper part of the scan electrode SCp and the upper part of the sustain electrode SUp in the first sustain discharge in addition to the positive sustain pulse voltage Vsus so as to become larger than the discharge start voltage, whereby the second sustain discharge occurs. Thereafter, the sustain pulse is similarly alternately applied to the scan electrodes SC1 to SCn and the sustain electrodes SU1 to SUn, so that the sustain discharge is continuously carried out by the number of sustain pulses with respect to the discharge cell Cp, q that caused the write discharge.

### Plasma Display Apparatus

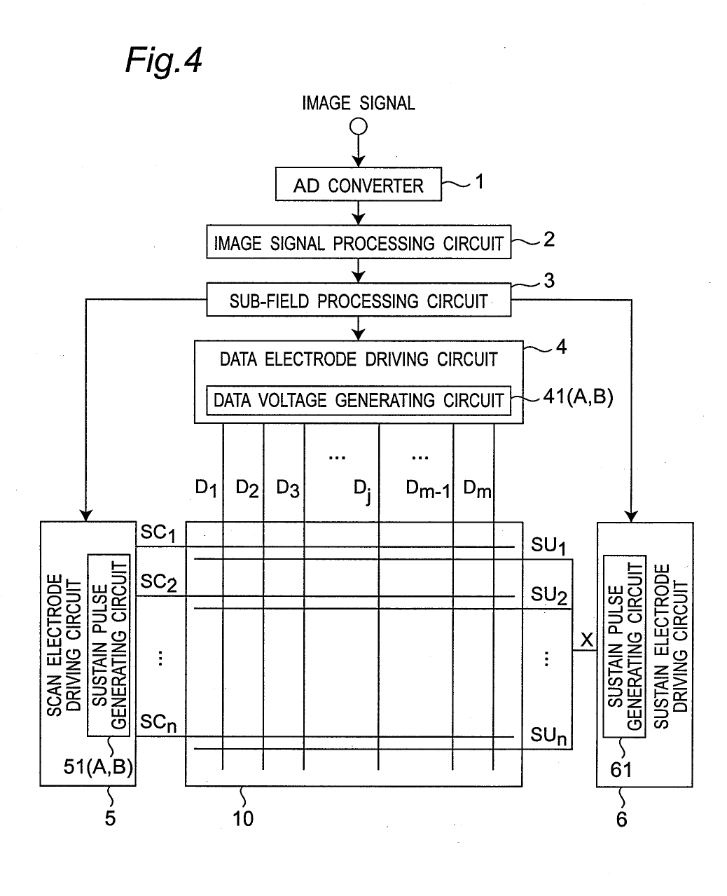

FIG. 4 is a block diagram showing an electrical configuration of a plasma display apparatus incorporating the PDP 10 according to the embodiment of the present invention. The plasma display apparatus shown in FIG. 4 includes an AD converter 1, an image signal processing circuit 2, a sub-field processing circuit 3, a data electrode driving circuit 4, a scan electrode driving circuit 5, a sustain electrode driving circuit 6, and the PDP 10.

The AD converter 1 converts an input analog image signal to a digital image signal. The image signal processing circuit 2 converts the input digital image signal to sub-field data for performing the control of each sub-field from the image signal of one field to display the same by light emission with a combination of a plurality of sub-fields having different weights for the light emission period.

The sub-field processing circuit 3 generates a data electrode driving circuit control signal, a scan electrode driving circuit control signal, and a sustain electrode driving circuit control signal from the sub-field data created in the image signal processing circuit 2, and outputs the same to the respective data electrode driving circuit 4, the scan electrode driving circuit 5, and the sustain electrode driving circuit 6.

The PDP 10, as described above, has the scan electrodes SC1 to SCn (scan electrode 22 of FIG. 1) of n rows and the sustain electrodes SU1 to SUn (sustain electrode 23 of FIG. 1) of n rows alternately arrayed in the row direction, and the data electrodes D1 to Dm (data electrode 32 of FIG. 1) of m columns arrayed in the column direction. Here, (m×n) discharge cells Ci, j including the pair of scan electrode SCi and sustain electrode SUi (i=1 to n), and one data electrode Dj (j=1 to m) is formed in the discharge space, where one pixel is configured by three discharge cells respectively emitting light of each color of red, green, and blue.

The data electrode driving circuit 4 independently drives each data electrode Dj based on the data electrode driving circuit control signal.

The scan electrode driving circuit 5 internally includes a sustain pulse generating circuit 51 (A, B) for generating the sustain pulse to be applied to the scan electrodes SC1 to SCn in the sustain period, and independently drives each scan electrode SC1 to SCn. Each scan electrode SC1 to SCn is independently driven based on the scan electrode driving circuit control signal.

The sustain electrode driving circuit 6 internally includes a sustain pulse generating circuit 61 for generating the sustain pulse to be applied to the sustain electrodes SU1 to SUn in the sustain period, and collectively drives all the sustain electrodes SU1 to SUn of the PDP 10. The sustain electrodes SU1 to SUn are driven based on the sustain electrode driving circuit control signal.

### Scan Electrode Driving Circuit And Sustain Electrode Driving Circuit

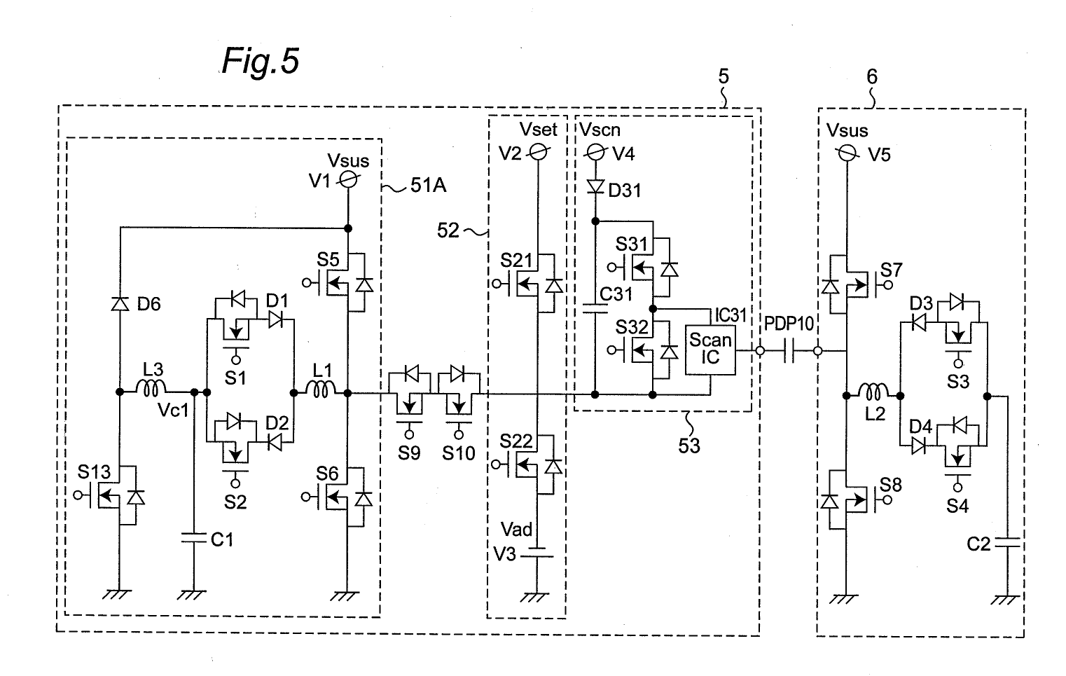

FIG. 5 is a circuit diagram of the scan electrode driving circuit 5 and the sustain electrode driving circuit 6 equipped with a power recovery unit in the PDP apparatus according to the first embodiment of the present invention.

In the PDP apparatus according to the first embodiment, power consumption is reduced by reusing the power recovered from the PDP 10 for the application of the sustain pulse voltage to the scan electrodes SC1 to SCn and the sustain electrodes SU1 to SUn in the sustain period, and reducing the power consumed in the sustain period.

In other words, a resonance circuit including an inductor, that is, the power recovery unit is arranged in the sustain pulse generating circuit 51A, and a configuration of recovering the power accumulated in the capacitive load (capacitive load generated in the scan electrodes SC1 to SCn) of the PDP 10, and reusing the recovered power for the drive power of the scan electrodes SC1 to SCn is adopted to reduce the power consumption. Similar power recovery unit is also arranged in the sustain pulse generating circuit 61, and a configuration of recovering the power accumulated in the capacitive load (capacitive load generated in the sustain electrodes SU1 to SUn) of the PDP 10, and reusing the recovered power for the drive power of the sustain electrodes SU1 to SUn might be adopted to reduce the power consumption. This will be specifically described below.

The scan electrode driving circuit 5 includes the sustain pulse generating circuit 51A, a reset waveform generating circuit 52, and a scan pulse generating circuit 53.

The sustain pulse generating circuit 51A switches the power recovery unit and the voltage clamp unit by switching each switch element S1, S2, S5, and S6, and generates the sustain pulse to be applied to the scan electrodes SC1 to SCn. In the sustain pulse generating circuit 51A using LC resonance, power is supplied by the power recovery unit until the voltage of the sustain pulse becomes a maximum value, and thereafter, drive using the power recovery unit, which theoretical power consumption is zero, to the utmost extent is carried out by switching the power recovery unit to the voltage clamp unit, whereby the power consumption of the scan electrode driving circuit 5 can be reduced.

The sustain pulse generating circuit 51A of the scan electrode driving circuit 5 will be hereinafter described in detail.

The reset waveform generating circuit 52 includes a generally known element that performs a switch operation such as MOSFET and IGBT. A reset positive pulse switch element S21, a reset negative pulse switch element S22, a constant voltage power supply V2 of voltage value Vset, and a constant voltage power supply V3 of negative voltage value Vad are arranged. The power is supplied from the constant voltage power supply V2 to the scan electrodes SC1 to SCn through the reset positive pulse switch element S21, and the power that becomes a negative potential is supplied from the constant voltage power supply V3 to the scan electrodes SC1 to SCn through the reset negative pulse switch element S22, thereby generating the reset waveform. The reset positive pulse switch element S21 is arranged in an orientation such that current does not flow into a main discharge path (path commonly connecting sustain pulse generating circuit 51A, reset waveform generating circuit 52, and scan pulse generating circuit 53, and through which the power to be supplied to the scan electrodes SC1 to SCn and the recovered power from the scan electrodes SC1 to SCn flow) from the constant voltage power supply V2 through the body diode (in the case of IGBT, diode having cathode connected to the collector terminal and anode connected to the emitter terminal (diode connected in this manner is hereinafter referred to as antiparallel diode)) when the reset positive pulse switch element S21 is shut down (shutdown of switch element is hereinafter abbreviated as “OFF”), and the reset negative pulse switch element S22 is arranged in an orientation such that current does not flow into the constant voltage power supply V3 from the main discharge path through the body diode (in the case of IGBT, antiparallel diode) when the reset negative pulse switch element S22 is turned OFF.

The reset waveform generating circuit 52 generates the reset waveform as described above, wherein an inclined waveform that gradually rises from the voltage Vi1 being lower than or equal to the discharge start voltage towards the voltage Vi2, that is, Vset exceeding the discharge start voltage with respect to the data electrodes D1 to Dn is generated in the first half of the reset period, and an inclined waveform that gradually falls from the voltage Vi3 being lower than or equal to the discharge start voltage towards the voltage Vi4, that is, Vad exceeding the discharge start voltage with respect to the sustain electrodes SU1 to SUn is generated in the second half of the reset period.

The scan pulse generating circuit 53 includes a high side scan switch element S31 and a low side scan switch element S32 made up of a generally known element that performs a switch operation such as MOSFET and IGBT, a constant voltage power supply V4 of voltage value Vscn, a scan voltage backflow prevention diode D31 for preventing current from flowing into the constant voltage power supply V4, a scan voltage capacitor C31, and an IC 31, which is a SCAN driver that has two input ports and outputs one of the powers input to the two input ports by the switch operation to generate the scan pulse waveform.

In the write period, scanning is carried out by sequentially applying a negative pulse to all the scan electrodes SC1 to SCn. Thus, in the write period, the high side scan switch element S31 is conducted (conduction of the switch element is hereinafter abbreviated as “ON”), and the power of voltage value Vscn supplied from the constant voltage power supply V4 through the scan voltage backflow prevention diode D31 and the high side scan switch element S31 is input to one of the input ports of the IC 31. The low side scan switch element S22 of the reset waveform generating circuit 52 is turned ON, and the power of negative voltage value Vad supplied from the constant voltage power supply V3 through the low side scan switch element 22 is input to the other input port of the IC 31. The power of either the power supplied from the constant voltage power supply V4 or the power supplied from the constant voltage power supply V3 is selected by the IC 31, and supplied to the scan electrodes SC1 to SCn. In other words, the IC 31 performs the switch operation to supply the power from the constant voltage power supply V3 at a timing of applying a negative scan pulse to the scan electrodes SC1 to SCn, and the power from the constant voltage power supply V4 at other times.

The switching of each switch element S1, S2, S5, S6, S21, S22, S31, and S32, and the IC 31 is controlled based on the sub-field control signal generated in the sub-field processing circuit 3.

A first separation switch element S9 and a second separation switch element S10 are inserted in series and so that the respective body diodes face opposite directions to each other between the sustain pulse generating circuit 51A and the reset waveform generating circuit 52 to electrically separate the sustain pulse generating circuit 51A from the reset waveform generating circuit 52. According to such configuration, both currents of the current flowing from the sustain pulse generating circuit 51A to the reset waveform generating circuit 52 and the current flowing from the reset waveform generating circuit 52 to the sustain pulse generating circuit 51A can be shut down by simultaneously turning OFF the first separation switch S9 and the second separation switch S10, and the sustain pulse generating circuit 51A can be electrically separated from the reset waveform generating circuit 52.

The sustain pulse generating circuit 61A of the sustain electrode driving circuit 6 will be hereinafter described in detail.

### Sustain Pulse Generating Circuit In Scan Electrode Driving Circuit

The sustain pulse generating circuit 51A according to the first embodiment of the present invention shown in FIG. 5 includes a power recovery unit with a first inductor L1, a first recovery capacitor C1, a first high side recovery switch element S1, a first low side recovery switch element S2, a first high side recovery diode D1, and a first low side recovery diode D2; and a voltage clamp unit with a first high side sustain switch element S5, a first low side sustain switch element S6, and a constant voltage power supply V1 of voltage value Vsus. The power recovery unit recovers and supplies power by LC-resonating the capacitive load (capacitive load generated in the scan electrodes SC1 to SCn) of the PDP 10 and the first inductor L1. In time of recovering power, the power accumulated in the capacitive load generated in the scan electrodes SC1 to SCn is moved to the first recovery capacitor C1 through the first low side recovery diode D2 and the first low side recovery switch element S2. In time of supplying power, the power accumulated in the first recovery capacitor C1 is moved to the PDP 10 (scan electrodes SC1 to SCn) through the first high side recovery switch element S1 and the first high side recovery diode D1. The drive of the scan electrodes SC1 to SCn in the sustain period is performed in such manner. Therefore, the power recovery unit performs the drive of the scan electrodes SC1 to SCn by LC resonance without being supplied with power from the power supply in the sustain period, and thus the power consumption is theoretically zero.

The voltage clamp unit clamps the scan electrodes SC1 to SCn to the voltage value Vsus by supplying power to the scan electrodes SC1 to SCn from the constant voltage power supply V1 of voltage value Vsus through the first high side sustain switch element S5, and clamps the scan electrodes SC1 to SCn to the ground potential through the first low side sustain switch element S6 to drive the scan electrodes SC1 to SCn. Therefore, in time of driving the scan electrodes SC1 to SCn by the voltage clamp unit, the impedance of the power supply is very small and the rise and fall of the sustain pulse is very steep, but power consumption occurs due to the supply of the power from the power supply.

Each switch element S1, S2, S5, and S6 is made up of a generally known element for performing a switch operation such as MOSFET. The MOSFET has a parasite diode (diode generated parasitizing from the structure of the MOSFET) generally called the body diode arranged in parallel to the portion where the switch operation is performed, and the anode and the cathode arranged in opposite directions (such configuration is hereinafter referred to as “antiparallel”) to the portion where the switch operation is performed. Thus, the switch element can flow current in the forward direction with respect to the body diode even if the switch operation is in the shield state. Alternatively, an antiparallel diode may be separately arranged using an element for performing the switch operation such as IGBT.

The sustain pulse generating circuit 51A according to the first embodiment of the present invention shown in FIG. 5 includes a control circuit. The control circuit includes a third inductor L3, a third low side recovery switch element S13, and a third recovery diode D6. A first end of the third inductor L3 is connected to a node between the first recovery capacitor C1 and the drain terminal of the first high side recovery switch element S1, and a second end of the third inductor L3 is connected to the drain terminal of the third low side recovery switch element S13 (collector terminal if the third low side recovery switch terminal S13 is a transistor such as IGBT). The source terminal (or emitter terminal) of the third low side recovery switch element S13 is connected to the GND terminal. The anode side of the third recovery diode D6 is connected to the drain terminal (or collector terminal) of the third low side recovery switch element S13, and the cathode side of the third recovery diode D6 is connected to the constant voltage power supply V1.

The third low side recovery switch element S13 performs a PWM operation of turning ON/OFF at a specific period according to a defined ON/OFF rate. The period of performing the PWM operation is in a range of about 2 microseconds to about 50 microseconds, and may be a fixed period or a variable period.

A method of setting the ON/OFF rate will now be described. The voltage Vc1 of the first recovery capacitor C1 and the reference voltage Vcs are compared, where the ON/OFF rate of the third low side recovery switch element S13 is set large (ON time is long, OFF time is short) if the Vc1 is larger than the reference voltage Vcs. If the reference voltage Vcs is larger than the Vc1, the ON/OFF rate is set small (ON time is short, OFF time is long). The voltage Vc1 of the first recovery capacitor C1 is controlled to become the reference voltage Vcs by performing such operation at a specific period. The ON/OFF rate is set with a maximum value in advance, and is limited so as to be lower than or equal to the maximum value. The maximum value is preferably set to a value of about 60% to 90%. The minimum value of the ON/OFF rate is 0%.

A detection means of the voltage Vc1, a comparison means with the voltage Vcs, and an operation signal generating means of the third low side recovery switch element S13 may be formed with an analog circuit such as an operational amplifier, may be formed with an integrated circuit such as a microcomputer or a control IC, or may be formed by combining these circuits. A control algorithm may use a known control algorithm of proportional control, proportional-plus-integral control, proportional-integral-differential control, and the like.

The setting of the reference voltage Vcs will now be described.

The reference voltage Vcs is set high when increasing the number of discharge pixels. The reference voltage Vcs is set low when decreasing the number of discharge pixels. The voltage Vc1 of the first recovery capacitor C1 is controlled to be equal to the reference voltage Vcs, and thus when forming a resonance circuit and carrying out the recovery operation during the sustain discharge period, the current passing through the first inductor L1 increases if the reference voltage Vcs is set high, and the current passing through the first inductor L1 decreases if the reference voltage Vcs is set low.

In the second related art described above, the first discharge has a problem in that the discharge intensity changes according to the number of discharge pixels since the current is regulated (limited) by the inductor. According to the first embodiment, the current flowing through the inductor can be increased by setting the reference voltage Vcs high if there are great number of discharge pixels. As a result, sufficient discharge current can be supplied to each discharge pixel, and the discharge intensity will not lower even if the number of discharge pixels is increased. On the contrary, the current flowing through the inductor can be reduced by setting the reference voltage Vcs low when the number of discharge pixels is small. As a result, requisite minimum discharge current can be supplied to each discharge pixel, and the discharge intensity will not become stronger even if the number of discharge pixels is decreased. Thus, the discharge intensity in the first discharge of supplying the discharge current from the inductor becomes constant irrespective of the number of discharge pixels by setting the reference voltage Vcs according to the number of discharge pixels. Therefore, the discharge intensity stabilizes even in the second discharge of flowing the current to the PDP 10 through the high side sustain switch element, and consequently, the luminance will not vary and high quality image can be displayed.

Other suitable settings of the reference voltage Vcs will now be described.

When desiring to set many tones and to set as many as possible luminance differences of the dark image in the case where the image to be displayed is a dark image, the reference voltage Vcs in the low tone sub-field, in particular, is set small. According to the present invention, the light emission luminance can be lowered so that the dark image can be displayed even by using the PDP 10 of high light emission efficiency in which one discharge intensity is strong. Therefore, in the low tone sub-field, the light emission luminance itself is lowered, and the high quality image is displayed. Furthermore, the capacitor voltage is lowered in the low tone sub-field, and at the same time, the number of sustain pulses is decreased in the high tone sub-field, so that an excess time is produced in one field. Therefore, the number of sub-fields can be increased and the tone can be further increased. The number of sustain pulses in each sub-field can be changed with increase or decrease in the reference voltage of the capacitor voltage. A plasma display panel driving device and a plasma display apparatus with higher quality are thereby provided by the present invention.

### Sustain Pulse Generating Circuit of Sustain Electrode Driving Circuit

The sustain pulse generating circuit 61 in the sustain electrode drive circuit 6 includes a power recovery unit with a second recovery inductor L2, a second recovery capacitor C2, a second high side recovery switch element S3, a second low side recovery switch element S4, a second high side recovery diode D3, and a second low side recovery diode D4; and a voltage clamp unit with a second high side sustain switch element, a second low side sustain switch element S8, and a constant voltage power supply V5 of voltage value Vsus, where the inductance of the capacitive load (capacitive load generated in the sustain electrodes SU1 to SUn) of the PDP 10 and the second recovery inductor L2 are resonated to cause the second recovery capacitor C2 to recover power.

The configuration of the sustain pulse generating circuit 61 in the sustain electrode driving circuit 6 may be made similar to that of the sustain pulse generating circuit 51A in the scan electrode driving circuit 5 described above to reuse the recovered power as the drive power of the sustain electrodes SU1 to SUn.

### Second Embodiment

In a plasma display panel driving circuit according to a second embodiment of the present invention, the control circuit of the sustain pulse generating circuit 51A described in the first embodiment is modified. The plasma display panel driving circuit and the plasma display apparatus of the present invention have a configuration similar to the first embodiment regarding the portions other than the control circuit of the sustain pulse generating circuit 51A, and thus the description thereof will be omitted.

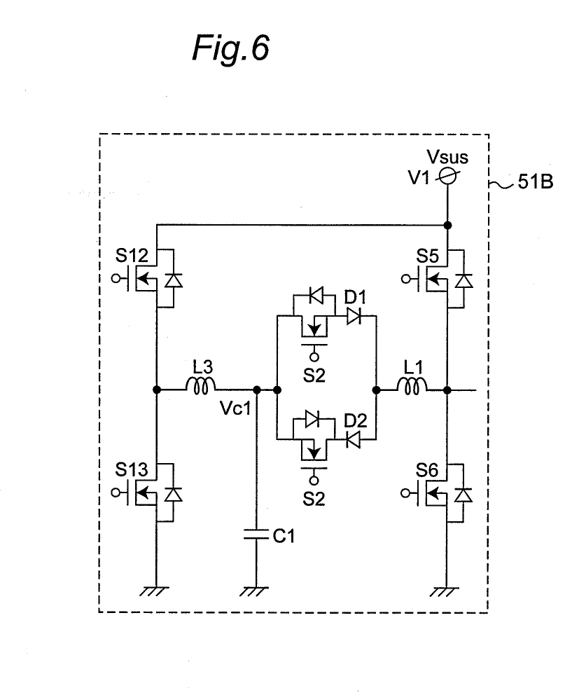

FIG. 6 is a circuit diagram of a sustain pulse generating circuit 51B including a control circuit according to the second embodiment of the present invention. Specific circuit configuration and connection configuration of the first inductor L1, the first recovery capacitor C1, the first high side recovery switch element S1, the first low side recovery switch element S2, the first high side recovery diode D1, the first low side recovery diode D2, the first high side sustain switch element S5, and the first low side sustain switch element S6 of the sustain pulse generating circuit 51B are similar to that of the sustain pulse generating circuit 51A according to the first embodiment (see FIG. 5).

The control circuit of the sustain pulse generating circuit 51B according to the second embodiment of the present invention includes the third inductor L3, the third low side recovery switch element S13, and a third high side recovery switch element S12. A first end of the third inductor L3 is connected to a node between the first recovery capacitor C1 and the drain terminal of the first high side recovery switch element S1, and a second end of the third inductor L3 is connected to the drain terminal of the third low side recovery switch element S13 (collector terminal if the third low side recovery switch terminal S13 is a transistor such as IGBT). The source terminal (or emitter terminal in the case of IGBT) of the third low side recovery switch element S13 is connected to the GND terminal. The source terminal (emitter terminal) of the third high side recovery switch element S12 is connected to the drain terminal (or collector terminal) of the third low side recovery switch element S13, and the drain terminal (collector terminal) of the third high side recovery switch terminal S12 is connected to the constant voltage power supply V1.

The third high side recovery switch element S12 and the third low side recovery switch element S13 perform a PWM operation of turning ON/OFF at a specific period according to a defined ON/OFF rate. One period of performing the PWM operation is in a range of about 2 microseconds to about 50 microseconds, and may be a fixed period or a variable period. One of the switch elements S12, S13 is always turned OFF, and a period in which both are simultaneously turned ON does not exist. The switch element S13 is preferably turned OFF during the period in which the switch element S12 is performing the PWM operation at a certain ON/OFF rate. The switch element S12 is preferably turned OFF during the period the switch element S13 is performing the PWM operation at a certain ON/OFF rate.

The setting of the ON/OFF rate will now be described. The voltage Vc1 of the first recovery capacitor C1 and the reference voltage Vcs are compared, where the ON/OFF rate of the third low side recovery switch element S13 is set large (ON time is long, OFF time is short) if the Vc1 is larger than the reference voltage Vcs. That is, if the third high side recovery switch element S12 is operating at an ON/OFF rate other than 0%, the ON/OFF rate of S12 is preferably reduced to 0%, and thereafter, the ON/OFF rate of S13 is set large.

If the reference voltage Vcs is larger than the Vc1, the ON/OFF rate of the third high side recovery switch element S12 is set large. That is, if the third low side recovery switch element S13 is operating at an ON/OFF rate other than 0%, the ON/OFF rate of S13 is preferably reduced to 0%, and thereafter, the ON/OFF rate of S12 is set large.

The voltage Vc1 of the first recovery capacitor C1 is controlled to become the reference voltage Vcs by performing such operation at a specific period. The ON/OFF rate of the third low side recovery switch element S13 is set with a maximum value in advance, and is limited so as to be lower than or equal to the maximum value. The maximum value is set to a value of about 60% to 90%. The minimum value of the ON/OFF rate is 0%. The minimum value of the ON/OFF rate of the third high side recovery switch element S12 is 0%, and the maximum value is 100%.

The detection means of the voltage Vc1, the comparison means with the voltage Vcs, and the operation signal generating means of the third high side recovery switch element S12 and the third low side recovery switch element S13 may be formed with an analog circuit such as an operational amplifier, may be formed with an integrated circuit such as a microcomputer or a control IC, or may be formed by combining the these circuits. A control algorithm may use a known control algorithm of proportional control, proportional-plus-integral control, proportional-integral-differential control, and the like. The method of setting the reference voltage Vcs is as described in the first embodiment, and thus will be omitted.

The voltage Vc1 of the first recovery capacitor C1 can follow the reference voltage Vcs at high speed by configuring the control circuit as in the second embodiment, whereby a plasma display panel driving circuit having better following property than the first embodiment can be provided. As a result, the discharge intensity further stabilizes, and an image display of high tone can be created.

### Third Embodiment

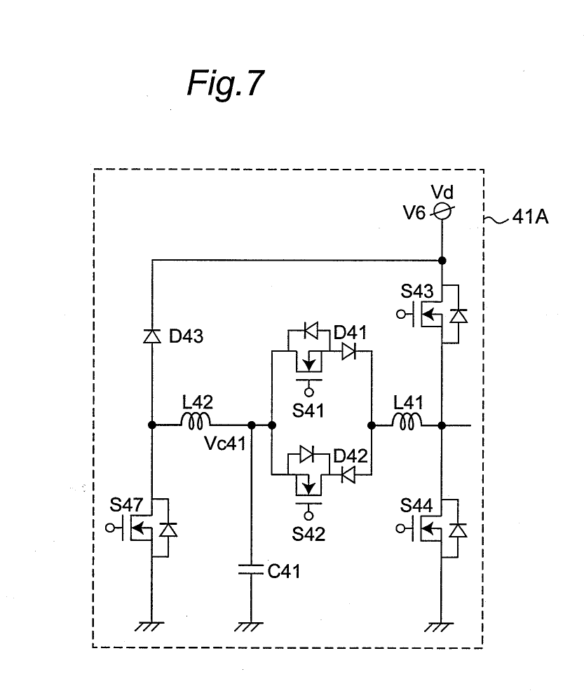

FIG. 7 is a circuit diagram of the data voltage generating circuit 41A according to a third embodiment of the present invention. The data voltage generating circuit 41A is arranged in the data electrode driving circuit 4 of the PDP apparatus (see FIG. 4).

The data voltage generating circuit 41A according to the third embodiment reduces power consumption in the write period. Similar to the scan electrode or the sustain electrode, the data electrode is also capacitive, and the charges accumulated in the panel can be recovered in the write period by arranging a circuit in the data electrode drive circuit similar to the recovery circuit unit arranged in the scan electrode (or sustain electrode) driving circuit.

A plasma display panel driving circuit and a plasma display apparatus according to the third embodiment of the present invention have a configuration similar to the first embodiment or the second embodiment regarding the portions other than the data voltage generating circuit 41A, and thus the description thereof will be omitted.

FIG. 7 is a circuit diagram of the data voltage generating circuit 41A including a control circuit according to the third embodiment of the present invention. The data voltage generating circuit 41A includes a data electrode drive inductor L41, a data electrode drive recovery capacitor C41, a data electrode drive high side recovery switch element S41, a data electrode drive low side recovery switch element S42, a data electrode drive high side recovery diode D41, a data electrode drive low side recovery diode D42, a data electrode drive high side sustain switch element S43, and a data electrode drive low side sustain switch element S44.

The circuit configuration and the connection configuration are similar to that of the sustain pulse generating circuit 51A according to the first embodiment (see FIG. 5).

The control circuit of the data voltage generating circuit 41A according to the third embodiment of the present invention includes a second data electrode drive inductor L42, a second data electrode drive low side recovery switch element S47, and a data electrode drive diode D43. A first end of the second data electrode drive inductor L42 is connected to a node between the data electrode drive recovery capacitor C41 and the drain terminal (collector terminal) of the first data electrode drive high side recovery switch element S41, and a second end of the second data electrode drive inductor L42 is connected to the drain terminal of the second data electrode drive low side recovery switch element S47. The source terminal (emitter terminal) of the second data electrode drive low side recovery switch element S47 is connected to the GND terminal. The anode side of the data electrode drive diode D43 is connected to the drain terminal (collector terminal) of the second data electrode drive low side recovery switch element S47, and the cathode side of the data electrode drive diode D43 is connected to a constant voltage power supply V6.

In other words, the circuit configuration and the connection configuration are similar to that of the sustain pulse generating circuit 51A according to the first embodiment.

The second data electrode drive low side recovery switch element S47 performs a PWM operation of turning ON/OFF at a specific period according to a defined ON/OFF rate. The period of performing the PWM operation is in a range of about 2 microseconds to about 50 microseconds, and may be a fixed period or a variable period.

The setting of the ON/OFF rate is similar to the first embodiment, and thus a detailed description will be omitted. That is, the third low side recovery switch element S13 in the driving circuit according to the first embodiment is replaced with the second data electrode drive low side recovery switch element S47. The first recovery capacitor C1 is replaced with the data electrode drive recovery capacitor C41, the voltage Vc4l of the data electrode drive recovery capacitor C41 is detected and compared with the reference voltage Vc4s, and the result is fed back to the ON/OFF rate, so that the second data electrode drive low side recovery switch element S47 is driven. The maximum value and the minimum value of the ON/OFF rate are also similar to the first embodiment. According to such configuration, the voltage Vc41 of the data electrode drive recovery capacitor C41 is controlled to maintain the reference voltage Vc4s.

The setting of the reference voltage Vc4s will now be described.

The reference voltage Vc4s is set according to the number of write discharge pixels of each scan line in the write period. The power recovery of an ideal data side panel capacity in the write period will be described. The relationship between the resonance time required in performing the recovery operation of recovering the panel capacity by LC resonance, and the time (hereinafter referred to as write idle time) from the termination of the negative scan pulse application by the scan electrode SCm to the start of the negative write pulse application to the next scan electrode SCm+1 during the write period is “2×TL=Ti” when expressed with an ideal equation that satisfies the condition of reducing the power consumption the most, where Ti(sec.) is the write idle time and TL is the resonance time. However, the electrostatic capacity of the data electrode side changes with the logical state of the pixel to be discharged, different from the panel capacity between the scan electrode and the sustain electrode. The pixel Cij in FIG. 2 will be described by way of example.

First, the electrostatic capacity between the data electrodes adjacent to each other in the left and right direction (scanning direction) will be described. The data electrode Dj is applied with the power supply voltage Vd when the pixel Cij carries out the write operation in the write period. In this case, if the pixel Cij−1 on the left side carries out the write operation, the power supply voltage Vd is applied to the data electrode Dj−1, and thus a potential difference is not created between the pixel Cij and the pixel Cij−1, and electrostatic capacity does not occur. If the pixel Cij−1 does not carry out the write operation, the ground potential is applied to the data electrode Dj−1, and thus a potential difference is created between the pixel Cij and the pixel Cij−1, and electrostatic capacity occurs. The electrostatic capacity differs depending on whether or not the adjacent pixel carries out the write operation. Similar relationship is obviously met with the pixel Cij+1 on the right of the pixel Cij. The electrostatic capacity between the adjacent data electrodes can be obtained by calculating the write operation over all the pixels of the PDP 10 with respect to the adjacent pixels. This calculation can be performed in the image signal processing circuit 2 or the sub-field processing circuit 3, and the electrostatic capacity between the data electrodes can be obtained based on the calculation result.

The electrostatic capacity between the data electrodes adjacent in the up and down direction (sub-scanning direction) will now be described. When the pixel Cij carries out the write operation in the write period of period i, the electrostatic capacity at the time of transitioning from period i−1 to period i does not change if write operation is carried out in period i−1 (by the pixel Ci-1j). The electrostatic capacity at the time of transitioning from period i−1 to period i changes if write operation is not carried out in period i−1 (by the pixel Ci-1j). Thus, the electrostatic capacity changes depending on whether or not to carry out the write operation with respect to the electrostatic capacity in the up and down direction as well. The change in the electrostatic capacity in the up and down direction can be obtained since the number of changes can also be calculated in the image signal processing circuit 2 or the sub-field processing circuit 3 similar to the above.

The change in two electrostatic capacities can be calculated in advance as the image to be displayed is determined in advance. Using the result of integrating the number in a case where the command value of the write operation in the pixels adjacent in the up and down, and left and right directions differ over all the pixels, the reference voltage Vc4s is set according to whether the result increase or decreases. In other words, if the result is increasing, the reference voltage Vc4s is set high since the electrostatic capacity increases. If the result is decreasing, the reference voltage Vc4s is set low. The voltage fluctuation is controlled so as to be optimum within the write idle time even if the resonance time changes in correspondence to the electrostatic capacity that changes according to the write state of the pixel by setting the reference voltage. Consequently, the recovered power from the data electrode is maximized, and power loss is reduced.

In the normal PDP, the capacity between the left and right data electrodes is larger than the capacity between the upper and lower electrodes, and thus addition can be carried out by weighting such that influence of the result in the left and right direction is large and the influence of the result in the up and down direction is small instead of simply adding the calculation result in the left and right direction and the calculation result in the up and down direction. The calculation of the upper and lower capacities may not be performed, and only the calculation result of the left and right capacities may be used. The recovered power is maximized by controlling the power recovery on the data electrode side.

Other suitable settings of the reference voltage Vc4s will now be described.

The setting described above is the setting of an ideal reference voltage Vc4s in the write period. When the change in the number of discharge pixels is small or when the change in the number of discharge pixels is negligible as a capacity since the original panel capacity is small, the resonance time barely changes. In this case, the reference voltage Vc4s during the write period may be held constant. If the power consumed as a result of the operation of the control circuit itself becomes larger than in the above-described method of performing the switch operation by changing the ON/OFF rate of the control circuit according to the number of discharge pixels, the power loss increases. Therefore, the setting to hold the value of the reference voltage Vc4s constant during the write period may be performed. The value of the reference voltage Vc4s to be held constant cannot be quantitatively set as it depends on the amount of change in the panel capacity involved in the change in the number of discharge pixels and the value of the panel capacity itself, but the power consumption reducing effect is large if set to a voltage value of about 50% to 90% of V6. The set value of the reference voltage Vc4s is obviously not limited thereto.

The panel capacity on the data electrode side can be appropriately recovered, and furthermore, the excessive power involved in recovery can be regenerated in the constant voltage power supply without being consumed in the resistor by configuring the data voltage generating circuit 41A as in the third embodiment, and thus power loss can be reduced. Furthermore, since the voltage of the recovery capacitor can be controlled, the recovered power from the panel capacity can be maximized and the power loss can be minimized. A plasma display panel driving circuit and a plasma display apparatus with small power consumption are obtained according to the present invention.

### Fourth Embodiment

In a plasma display panel driving circuit according to a fourth embodiment of the present invention, the control circuit of the data voltage sustain pulse generating circuit 41A described in the third embodiment is modified. Therefore, the plasma display panel driving circuit and the plasma display apparatus according to the fourth embodiment of the present invention have a configuration similar to that of the third embodiment regarding the portions other than the control circuit of the data voltage sustain pulse generating circuit 41A, and thus the description thereof will be omitted.

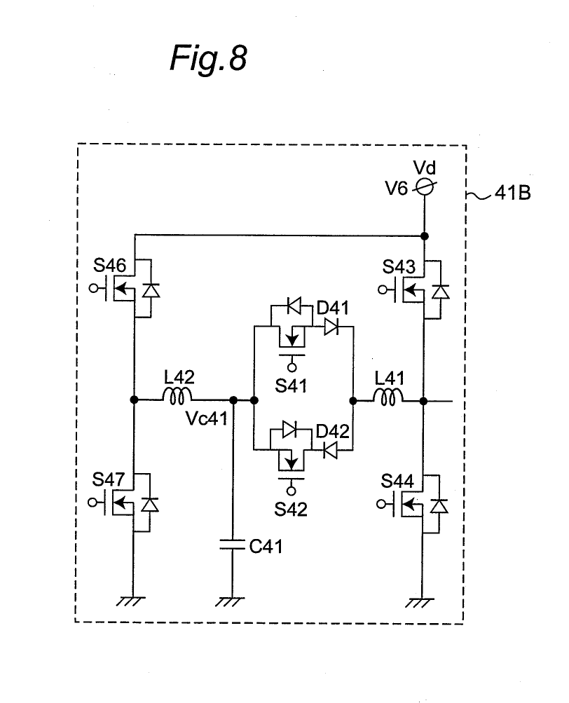

FIG. 8 is a circuit diagram of a data voltage generating circuit 41B including a control circuit according to a fourth embodiment of the present invention. The data voltage generating circuit 41B includes the data electrode drive inductor L41, the data electrode drive recovery capacitor C41, the data electrode drive high side recovery switch element S41, the data electrode drive low side recovery switch element S42, the data electrode drive high side recovery diode D41, the data electrode drive low side recovery diode D42, the data electrode drive high side sustain switch element S43, and the data electrode drive low side sustain switch element S44, and the circuit configuration and the connection configuration are similar to that of the data voltage sustain pulse generating circuit 41A according to the third embodiment.

The control circuit of the data voltage generating circuit 41B according to the fourth embodiment of the present invention is similar to the control circuit of the sustain pulse generating circuit 51B according to the second embodiment described above. That is, the control circuit of the data voltage generating circuit 41B according to the fourth embodiment includes the second data electrode drive inductor L42, the second data electrode drive low side recovery switch element S47, and the second data electrode drive high side recovery switch element S46. A first end of the second data electrode drive inductor L42 is connected to a node between the data electrode drive recovery capacitor C41 and the drain terminal (collector terminal) of the first data electrode drive high side recovery switch element S41, and a second end of the second data electrode drive inductor L42 is connected to the drain terminal of the second data electrode drive low side recovery switch element S47. The source terminal (emitter terminal) of the second data electrode drive low side recovery switch element S47 is connected to the GND terminal. The source terminal (emitter terminal) of the second data electrode drive high side recovery switch element S46 is connected to the drain terminal (collector terminal) of the second data electrode drive low side recovery switch element S47, and the drain terminal (collector terminal) is connected to the constant voltage power supply V6.

The setting of the ON/OFF rate of the second data electrode drive high side recovery switch element S46 and the second data electrode drive low side recovery switch element S47 is similar to that described in the second embodiment, and thus the description thereof will be omitted. The setting of the reference voltage Vc4s, which is a voltage target of the voltage Vc41 of the data electrode drive recovery capacitor C41, is similar to that described in the third embodiment, and thus the description thereof will be omitted (see FIG. 7).

As described in the second embodiment, the voltage of the data electrode drive recovery capacitor C41 can follow the reference voltage at higher precision by further arranging the second data electrode drive high side switch element S46 in the control circuit, and thus power consumption can be further reduced.

### Fifth Embodiment

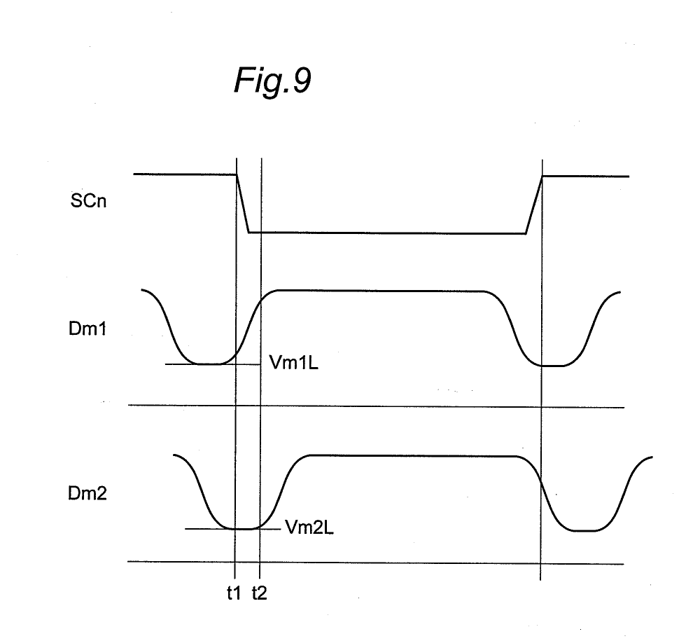

A plasma display apparatus according to a fifth embodiment of the present invention includes at least two or more data electrode driving circuits of the third or the fourth embodiment. The voltage application timings of the write operation differ between the two data electrode driving circuits. The two voltage application timings are as shown in FIG. 9 described below.

The plasma display apparatus according to the fifth embodiment has a means for solving the problem in that write operation cannot be correctly performed that arise with larger screen and higher definition of the panel. That is, if the screen becomes larger and the definition becomes higher, the address discharge current increases, large voltage drop occurs over the scan pulse, and a phenomenon in that write operation becomes unstable occurs. A means for changing the timing of data application voltage is thus used to prevent instability of the write operation.

FIG. 9 is a view showing a waveform of the voltage SCn of the scan electrode in the write period, as well as the voltages Dm1 and Dm2 of the data electrodes with different timings. There is arranged two different data electrode driving circuits such as one for Dm1 in which the high side recovery switch element S41 of the data electrode recovery circuit is turned ON and the data electrode voltage rises after a negative scan pulse is applied at time t1, and the other for Dm2 in which the high side recovery switch element S41 is turned ON and the data electrode voltage rises at time t2 after a predetermined time has elapsed from t1. Thus, the time of generating the address discharge is differed by differing the timing of voltage to be applied to the data electrode, whereby the peak value of the address discharge current becomes small and the write operation stabilizes.

The main purport of the fifth embodiment of the present invention is not only on the shift of the voltage application timing as described above, but also on the setting of the reference voltage for controlling the recovery capacitor voltage in a plurality of data electrode driving circuits with different voltage application timings as shown in FIG. 9. The set value of the reference voltage differs from that of the third or the fourth embodiment. The data electrode driving circuit for applying voltage to the data electrode as in the voltage application waveform Dm1 may be similar to that for setting the reference voltage Vc4s shown in the third or the fourth embodiment, but the data electrode driving circuit for driving Dm2 with later voltage application timing differs from that shown in the third or the fourth embodiment.

The reference voltage Vc4s of the data electrode driving circuit for driving the voltage application waveform Dm² is set such that the voltage value Vm2L of the Dm2 in a period from t1 to t2 of applying voltage to the data electrode after the scan pulse is applied becomes a voltage value low enough not to decrease wall charges. The voltage of the voltage value Vm2L becomes high if the voltage of the recovery capacitor is high, and the voltage of the voltage value Vm2L becomes low if the voltage of the recovery capacitor is low. Therefore, the value of the Vm2L such that the address operation does not become unstable is experimentally obtained, and the voltage value of the recovery capacitor is determined so as to be smaller than or equal to the obtained Vm2L. The recovery capacitor voltage in this case changes according to conditions such as number of pixels to be lighted, and thus the Vc4s may be set according to the panel capacity as in the third embodiment, or may be set to a constant value during the write period.

### Sixth Embodiment

A plasma display apparatus according to a sixth embodiment of the present invention includes at least two or more data electrode driving circuits of the third or the fourth embodiment, similar to the fifth embodiment. Similar to the fifth embodiment, the voltage application timings of the write operation differ between the two data electrode driving circuits, and the two voltage application timings are also as described in FIG. 9 described above.

The main purport of the sixth embodiment of the present invention is to differ the inductance value of the first data electrode drive inductor L41 of the respective data electrode driving circuit in a plurality of data electrode driving circuits with different voltage application timings as shown in FIG. 9.

That is, the value of the Vm2L becomes larger the larger the first data electrode drive inductor L41, and the value of the Vm2L becomes smaller the smaller the first data electrode drive inductor L41. Therefore, the inductance value L41m1 of the first data electrode drive inductor L41 used in the data electrode drive circuit which outputs the voltage application waveform Dm1, and the inductance value L41m2 of the first data electrode drive inductor L41 used in the data electrode drive circuit which outputs the voltage application waveform Dm2 are set to different values. For instance, L41m2 may set to a range of about 1.5 times to 4 times the L41m1. That is, L41m2 is set to a value larger than L41m1. The Vm2L thus becomes larger than Vm1L, whereby the power consumption on the Dm1 side is reduced, and the write operation stabilizes on the Dm2 side.

### Other Embodiments

Each switch element described from the first to the fourth embodiments may be IGBT, MOSFET, or transistor using GaN or SiC. FIG. 5 to FIG. 8 are circuit diagrams illustrated in consideration of the MOSFET, and the description of the embodiment is also made in consideration of the MOSFET, but the present invention is not limited to the MOSFET. The antiparallel diode may be connected in the case of a transistor such as IGBT that does not internally include a parasitic diode.

### INDUSTRIAL APPLICABILITY

The present invention relates to a plasma display panel driving circuit and a plasma display apparatus, and is industrially useful in that power consumption can be reduced, image quality can be enhanced, and the like.

1-17. (canceled)

18. A plasma display panel driving circuit for temporarily forming an LC resonance circuit by connecting an induction element, a switch, and a capacitor to a display panel to supply and recover power with respect to a load capacity of the display panel before and after applying a predetermined voltage to the display panel including the load capacity; the plasma display panel driving circuit comprising:
a control circuit for varying the voltage of the capacitor, wherein the control circuit controls the voltage of the capacitor to match a reference electrode, and causes a power supply source to recover the power when lowering the voltage of the capacitor.

19. The plasma display panel driving circuit according to claim 18, wherein the control circuit is configured by,
an induction element having a first end of the induction element connected to the capacitor;
a transistor having a collector terminal connected to a second end of the induction element, and an emitter terminal connected to a negative side power supply of a sustain voltage; and
a diode having an anode side connected to the collector terminal of the transistor and a cathode side connected to a positive side power supply of the sustain voltage.

20. The plasma display panel driving circuit according to claim 18, wherein the control circuit is configured by,
an induction element having a first end connected to the capacitor;
a first transistor having a collector terminal connected to a second end of the induction element, and an emitter terminal connected to a negative side power supply of a sustain voltage;
a first diode having a cathode side connected to the collector terminal of the first transistor and an anode side connected to the emitter terminal;
a second transistor having an emitter terminal connected to the collector terminal of the first transistor, and a collector terminal connected to a positive side power supply of the sustain voltage; and
a second diode having a cathode side connected to the collector terminal of the second transistor, and an anode side connected to the emitter terminal.

21. The plasma display panel driving circuit according to claim 18, wherein the control circuit varies the voltage of the capacitor for every sub-field.

22. The plasma display panel driving circuit according to claim 18, wherein the control circuit varies the voltage of the capacitor according to a lighting rate.

23. The plasma display panel driving circuit according to claim 18, wherein the control circuit reduces the capacitor voltage for sub-fields with few tones.

24. The plasma display panel driving circuit according to claim 22 wherein the control circuit varies number of sustain pulses according to the capacitor voltage.

25. The plasma display panel driving circuit according to claim 18, wherein the control circuit is formed by being connected to the LC resonance circuit configured by being connected to at least a sustain electrode or a scan electrode.

26. The plasma display panel driving circuit according to claim 18, wherein the control circuit is formed by being connected to the LC resonance circuit configured by being connected to a data electrode.

27. The plasma display panel driving circuit according to claim 26, wherein the control circuit varies the voltage of the capacitor according to change in logical level between adjacent pixel to be address discharged.

28. The plasma display panel driving circuit according to claim 26, wherein the control circuit holds the voltage of the capacitor during a write period in one sub-field.

29. A plasma display apparatus comprising the plasma display panel driving circuit according to claim 25.

30. The plasma display apparatus according to claim 29, further comprising:
at least two or more LC resonance circuit connected to a data electrode;
a first control circuit connected to the first LC resonance circuit; and
a second control circuit connected to the second LC resonance circuit; wherein
a power supply and recovery operation performed by the first LC resonance circuit is faster than a power supply and recovery operation preformed by the second LC resonance circuit.

31. The plasma display apparatus according to claim 30, wherein the first control circuit and the second control circuit are operated so that a capacitor voltage of the first LC resonance circuit and a capacitor voltage of the second LC resonance circuit are different.

32. The plasma display apparatus according to claim 31, wherein the capacitor voltage of the first LC resonance circuit is greater than the capacitor voltage of the second LC resonance circuit.

33. The plasma display apparatus according to claim 32, wherein an inductance of an induction element of the first LC resonance circuit is greater than an inductance of an induction element of the second LC resonance circuit.

34. A plasma display apparatus comprising the plasma display panel driving circuit according to claim 26.

35. The plasma display apparatus according to claim 34, further comprising:
at least two or more LC resonance circuit connected to a data electrode;
a first control circuit connected to the first LC resonance circuit; and
a second control circuit connected to the second LC resonance circuit; wherein
a power supply and recovery operation performed by the first LC resonance circuit is faster than a power supply and recovery operation preformed by the second LC resonance circuit.

36. The plasma display apparatus according to claim 35, wherein the first control circuit and the second control circuit are operated so that a capacitor voltage of the first LC resonance circuit and a capacitor voltage of the second LC resonance circuit are different.

37. The plasma display apparatus according to claim 36, wherein the capacitor voltage of the first LC resonance circuit is greater than the capacitor voltage of the second LC resonance circuit.

38. The plasma display apparatus according to claim 37, wherein an inductance of an induction element of the first LC resonance circuit is greater than an inductance of an induction element of the second LC resonance circuit.
